(19) United States
(12) Patent Application Publication
(10) Pub. No.: US 2010/0088169 A1
(43) Pub. Date: Apr. 8, 2010

(54) METHODS AND WEBPAGES FOR COMMERCE AND INFORMATION EXCHANGE

(75) Inventor: David M. CHAO, Kansas City, MO (US)

Correspondence Address: CLARK & ELBING LLP, 101 FEDERAL STREET, BOSTON, MA, 02110, US

(73) Assignee: Aptakon, Kansas City, MO (US)

(21) Appl. No.: 12/576,088

(22) Filed: Oct. 8, 2009

Related U.S. Application Data
(60) Provisional application No. 61/103,802, filed on Oct. 8, 2008.

(51) Int. Cl. G06Q 99/00; G06Q 10/00; G06Q 30/00; G06Q 50/00; G06F 3/048

(52) U.S. Cl. 705/14.19; 705/347; 715/760

(57) ABSTRACT

The invention provides methods and webpages for commerce and information exchange wherein a seller offers to consumers one or more products or services on a webpage that facilitates the exchange of information (e.g., product reviews, rankings, and applications data) and compensation between the seller and consumers or between consumers.

### CROSS-REFERENCE TO RELATED APPLICATIONS

This application claims the benefit of the filing date of U.S. provisional patent application No. 61/103,802, filed Oct. 8, 2008, the disclosure of which is hereby incorporated by reference.

### FIELD OF THE INVENTION

The invention provides methods and webpages for commerce and information exchange wherein a seller offers to consumers one or more products or services on a webpage that facilitates the exchange of information (e.g., product reviews, rankings, and applications data) and compensation between the seller and consumers or between consumers.

### BACKGROUND OF THE INVENTION

Commercial sites on the Internet (e.g., webpages, especially on the World Wide Web) are known. Typically, webpages where products and services can be purchased or auctioned consist of a static description of the products and services offered, the price at which such products or services are offered by a seller (e.g., a webpage owner, administrator, or business entity), and some type of order form or field for a consumer (e.g., an end-user, customer, or client) to enter personal and payment information. Amazon.com and eBay.com are examples of commercial webpages that sell or auction products and services. Similarly, webpages soliciting products or services consist of a static description of the products or services sought, the price at which such products or services can be purchased, and an order form or response mechanism for a consumer to enter personal or financial information.

State-of-the-art webpages are not optimally suited for the purchase of products or services that are unique, sophisticated, or novel. For example, products and services commonly marketed to and purchased by the pharmaceutical and biotechnology industries for unique applications, such as antibodies, nucleic acid and peptide synthesis services, and diagnostic assay services are often complex and difficult to describe. In many cases, certain detailed information concerning, for example, the quality (e.g., purity, durability, integrity, and accuracy), application (methods and range of use), reactivity profile, storage (temperature, duration), and safety (e.g., flammability, toxicity) is not known or available to the seller, and by extension not made available to the consumer. The sheer scope of potential applications and methods of use of a particular good or service can hamper the seller's ability to adequately or fully disclose useful information that a consumer would find helpful in deciding to purchase the particular good or service. Furthermore, commercial webpages are generally interactive only to the extent that a consumer is able to choose a particular product or service for purchase and to enter payment and shipment information. Some commercial webpages, for example, Amazon.com, allow the consumer to provide a brief review, comment, or rating of a product, information offered by the seller, but this option is only open to those have previously purchased the product in question. Such websites do not allow a consumer to solicit helpful reviews, advice, or other information (e.g., applications data) from other consumers or the seller, or to arrange for an exchange of compensation for payment in kind. Accordingly, state of the art commerce conducted on websites and webpages is vertically oriented (i.e., between the seller/host and consumer) and does not facilitate the horizontal exchange of information or compensation between consumers. Thus, there exists a need for a dynamic and interactive computer-implemented method of conducting commerce and information exchange that allows for the increased exchange of information and compensation between consumers interested in particular products and services.

### SUMMARY OF THE INVENTION

In a first aspect, the invention provides a method for commerce and information exchange by (a) listing one or more products or services on a webpage, (b) registering a first consumer and a second consumer, wherein the first and second consumers are not affiliated or associated with the operation or ownership of the webpage, and (c) publishing informational indicia of the products or services on the webpage, wherein the indicia are solicited by the first consumer and provided by the second consumer, or processing an exchange of compensation between the first and second consumers upon publication of the indicia. In one embodiment, the method further includes the processing of an exchange of compensation between the first and second consumers upon publication of informational indicia relating to one or more products or services on the webpage.

In a second aspect, the invention provides a method for commerce and information exchange by (a) listing one or more products or services on a webpage, (b) registering a first consumer and a second consumer, wherein the first and second consumers are not affiliated or associated with the operation or ownership of the webpage, and (c) processing an exchange of compensation between the first and second consumers upon publication of informational indicia relating to one or more products or services on said webpage.

In a third aspect, the invention provides a webpage for commerce and information exchange that has (a) a webpage that lists one or more products or services, (b) the means for registering a first consumer and a second consumer, wherein the first and second consumers are not affiliated or associated with the operation or ownership of the webpage, and (c) the means for publishing informational indicia of the products or services on the webpage, wherein the indicia are solicited by the first consumer and provided by the second consumer. In one embodiment, the webpage further includes the means for processing an exchange of compensation between the first and second consumers upon publication of the indicia.

In a fourth aspect, the invention provides a webpage for commerce and information exchange that has (a) a webpage that lists one or more products or services, (b) the means for registering a first consumer and a second consumer, wherein the first and second consumers are not affiliated or associated with the operation or ownership of the webpage, and (c) the means for processing an exchange of compensation between the first and second consumers upon publication of the indicia.

In one embodiment of any aspect of the invention, the service is the manufacture, purification, or distribution of a biological or chemical product. In another embodiment, the product is a biological or chemical product. Biological products include e.g., proteins (e.g., antibodies, antibody fragments, binding agents, hormones, cytokines, growth factors, enzymes (e.g., restriction endonucleases, polymerases, reverse transcriptases, ligases, nucleases, methyltransferases, kinases, phosphatases, sulfurylases, recombinases, proteases, and luciferases)); lipids; nucleic acids (e.g., plasmids, artificial chromosomes); sugars; plants; reagents (e.g., transfection reagents, laboratory chemicals); viruses; cells (e.g., bacterial (e.g., Escherichia coli), fungal (e.g., yeast), insect, and animal (e.g., mammalian) cells); and animals (e.g., rodents, ungulates, and non-human primates).

In another embodiment of any aspect of the invention, the informational indicia are reviews, critiques, explanations, survey scores, or rankings, including reviews, critiques, and explanations that relate to previously published informational indicia. In one embodiment, the informational indicia are drawings, photographs, or videos. In another embodiment, the informational indicia are scientific data, such as a chart, graph, or table. Scientific data can be generated by Western blot, Southern blot, Northern blot, dot blot, immunoprecipitation, immunohistochemistry, immunofluorescence, fluorescent in situ hybridization (FISH), fluorescence-activated cell sorting (FACS), magnetic affinity cell sorting (MACS), enzyme-linked immunosorbent assay (ELISA), enzyme-linked immunosorbent spot (ELISPOT), polymerase chain reaction (PCR), restriction enzyme digestion, genomic or gene array analysis, or mass spectrometry.

In a further embodiment of any aspect of the invention, a third consumer is registered on the webpage of the invention. In one embodiment, the invention provides for the publication of consumer information, such as identification, contact information, employment history, publication history, a skill summary, a resource summary, availability, and fee, on the webpage. The webpage of the invention can be publicly accessible. In another embodiment, the compensation can be money, a trade discount, or a discount towards the purchase or use of the listed products or services. In one embodiment, the trade credit or discount is provided by the seller to a first consumer, wherein the trade credit or discount can only be used by the first consumer to compensate a second or third consumer that provides informational indicia concerning a listed product or service in response to a solicitation for information indicia made by the first consumer. The compensation can also be a gift. The trade credit can be restricted to the purchase of products, services, or informational indicia (including, e.g., a review of previously published informational indicia), including defined groups or subsets of products, services, or informational indicia.

### DEFINITIONS

A “seller”, “administrator”, “owner”, or “host” is a person or entity (e.g., a business, corporation, government, or university) that operates or administers a website or webpage that advertises one or more products or services according to the methods of the invention.

A “consumer” is a person or entity that accesses a webpage of the invention seeking to purchase, lease, rent, or receive one or more products or services offered by the host according to the methods of the invention. Consumers can also solicit or provide indicia relating to products or services offered by a seller on a webpage. In one embodiment of the invention, consumers do not have a pre-existing financial, fiduciary, contractual or other obligation to the webpage seller (e.g., webpage owner, host, or administrator). In another embodiment, a consumer can be affiliated or associated with the webpage seller.

A “webpage user” is either a seller or consumer, as defined herein.

### BRIEF DESCRIPTION OF THE DRAWINGS

FIG. 1 is a diagram contrasting state-of-the-art methods of webpage-based commerce with the methods of the present invention. (a) Current methods of webpage-based commerce allow for an end-user (e.g., a consumer) to provide indicia (e.g., applications data) concerning a product or service only after purchasing the product or service. (b) In one embodiment of the methods of the invention, multiple end-users participate at different stages of the production and commercialization of a product. As illustrated here, different end-users can solicit the production of a product, solicit indicia of the product, produce and publish the indicia on the webpage, and participate in an exchange of compensation in return for contributions of product indicia.

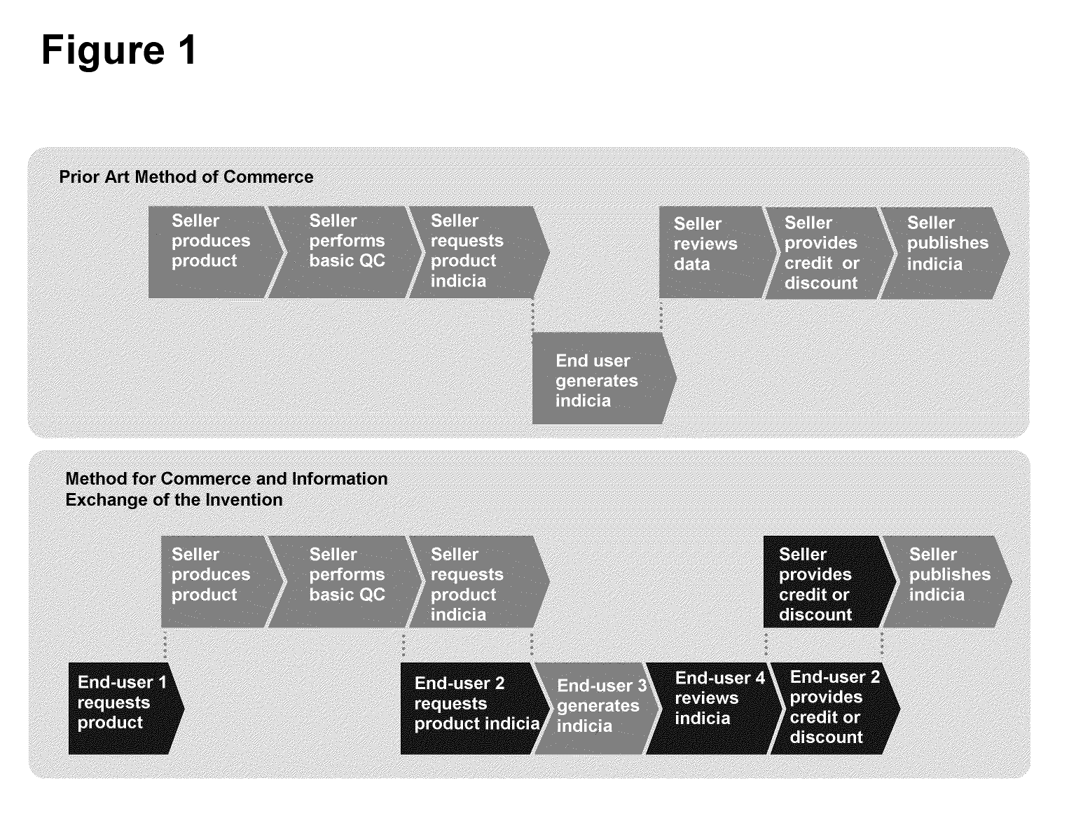

### DETAILED DESCRIPTION OF THE INVENTION

In the following description, for purposes of explanation and not limitation, specific details are set forth in order to provide a thorough understanding of the present invention. However, it will be apparent to one skilled in the art that the present invention may be practiced in other embodiments that depart from these specific details. In other instances, detailed descriptions of well-known methods and devices are omitted so as to not obscure the description of the present invention with unnecessary detail.

### A Method for Commerce and Information Exchange

The present invention features a method for commerce and information exchange that allows for the request, purchase, and review of advertised products and services via a networked computer system, such as an Internet webpage (e.g., World Wide Web) or other method of electronic peer-to-peer (e.g., “P2P” systems) communication. In contrast to established commercial websites and webpages that facilitate the transfer (e.g., sale, lease, auction, or donation) of products and services (e.g., Amazon.com and eBay.com), the present method provides for increased consumer participation and input in the solicitation and review of offered products or services, as well as increased options for the exchange of compensation between the seller (e.g., the webpage owner, administrator, or host) and participating consumers or directly between consumers. The method of the invention is presented in further detail below, along with a discussion of the advantages this method offers over the state of the art.

### Webpages of the Invention

A webpage of the invention contains information relating to the products or services being offered, including price, dimensions, quality (e.g., purity), quantity, intended use, and, as appropriate, photographs, videos, illustrations, figures, spreadsheets, or charts. This information can be provided instantly on the webpage relating to the product or service, or in an ancillary webpage or document (e.g., a downloadable Adobe PDF or Microsoft Word file) linked to the relevant webpage. Webpages of the invention also contain one or more fields that allow for the publication of comments (e.g., solicitations, reviews) and product or service indicia. Ideally, these entry fields will record the unique identifier (e.g., username) and time of entry.

### Sellers and Consumers

The seller is responsible for registering consumers by collecting identifying information such as name, place of business, and contact information. Typically, upon receipt of this information, a seller will issue a unique username (e.g., a log-in name) that serves to identify the consumer to both the seller and other consumers without requiring the broad or repeated disclosure of personal information. The assignment of a unique username or account to a consumer allows all actions and communications performed by that consumer to be recorded and reviewed by both the seller and other consumers who may use this information to ascertain the credibility or motive for actions, e.g., comments, conducted on the webpage. Alternatively, the registration of a consumer can allow for the shielding of identifying or other personal information from the seller or other consumers. Protecting the identity of a consumer from others, including the seller, may be a desirable feature of a webpage of the invention depending on the nature of the relevant commercial or personal context.

### Products and Services

The products and services suitable for marketing and exchange according to the methods of the invention are essentially without limit. As used herein, “goods” refers to any tangible asset that can be legally sold, auctioned, leased, or given to a consumer upon request. “Services” refers to any valuable performance offered by a seller to a consumer. The products and services of the invention can be manufactured or performed by the seller or by a third-party under contract with the host.

Commercial industries that may particularly benefit from the webpage and methods of the invention are those that sell, buy, or trade novel, unique, or complex products and services. These industries include, e.g., the automotive, construction, travel/tourism, and textile industries. Informational indicia relating to products and services offered by these (e.g., a car muffler, roofing tiles, a cruise ship experience, or fabric quality), and other, industries can be solicited and published according to the methods of the invention.

### Informational Indicia of Products and Services

A webpage user can request indicia relating to any particular product or service offered on a webpage of the invention. The informational indicia can be comments, reviews, rankings, scores, data, charts, or media (e.g., photographs, video, and audio (e.g., music)) that serve to educate and guide the decision-making of a consumer interested in a particular product or service available for an exchange of compensation (e.g., for sale, lease, rent, or donation). Typically, the indicia relate to the quality, quantity, use, application (e.g., applications data), and safety of the offered product.

In one embodiment of the invention, consumers who have previously purchased or used a product or service contribute indicia that relates to their individual working experience with the service or product. The ability of a consumer to contribute informational indicia relating to a particular product or service is not contingent on any previous purchase from the seller. Any registered user of the website, including the seller, can publish informational indicia relating to a particular product or service.

In another embodiment of the invention, a webpage user (e.g., a consumer or seller) can solicit informational indicia concerning a product or service by posting a request on the relevant webpage. In response to this solicitation, another webpage user that has previously purchased or used the product or service in question can provide (e.g., publish on the webpage) the requested indicia. Informational indicia of the invention also include “secondary” informational indicia, such as, for example, reviews, critiques, or explanations published in response to previously published “primary” informational indicia. Secondary informational indicia expand on the disclosures of previously published primary informational indicia by providing subjective analysis or commentary on the informational indicia, the techniques used to generate the indicia, or the webpage users submitting the indicia. For example, consumer “A” can publish a review a critique of informational indicia (e.g., scientific data) previously published by consumer “B.” In so doing, the webpage becomes a site for the exchange of information relating to a product or service, and allows all interested parties (e.g., consumers and sellers) to benefit from the breadth of knowledge shared on the webpage. This exchange of information is augmented by providing each participating consumer with a financial or material incentive (i.e., an exchange of compensation) to solicit or provide informational indicia, as discussed further below.

In a further embodiment of the invention, a webpage user (e.g., a seller or consumer) can directly solicit informational indicia from any other webpage user. The ability to directly solicit informational indicia is particularly helpful when the solicited webpage user is known to have superior knowledge (e.g., experience) or ability (e.g., fee and availability) to provide such indicia. To facilitate the direct solicitation of informational indicia, a webpage user can publish consumer information that would be useful to other users of the website (e.g., other consumers or a seller) seeking to solicit informational indicia. For example, a consumer can provide a resume or curriculum vitae (CV) for publication on the webpage. Consumer information such as identification (e.g., name, address, contact information), employment history and experience, publication history (e.g., scientific publication citations), a skill summary, a resource summary, availability, and pricing can be helpful to webpage users seeking to solicit informational indicia relating to an advertised product or service. Accordingly, consumers can “market” their ability to provide informational indicia to other webpage users seeking to solicit such information. In response, webpage users can rank or review the informational indicia provided by another webpage user, as described above.

### Exchange of Compensation

The current standard in webpage-based commerce allows a consumer to purchase a product or service in exchange for monetary consideration. Typically, the consumer will supply payment information (e.g., credit card number, bank account number, etc.) that facilitates the transfer of an agreed-upon sum of money from the consumer to the seller or designated agent (e.g., a bank). The methods of the present invention allow for increased flexibility and opportunity in the exchange of compensation. For example, as incentive for publishing informational indicia on a webpage in response to a solicitation, a webpage user (e.g., the seller or a consumer) can offer money, a trade credit, a discount, a gift, or other product or service. Thus, the present invention provides for the ability of webpage users, both the seller and consumers, to solicit and provide informational indicia relating to an advertised product or service, and to offer and provide an exchange of compensation as incentive and reward for the provision (e.g., publication) of the informational indicia.

In one embodiment of the invention, a seller provides consumers with a special trade credit or discount that can only be used to compensate another consumer that provides informational indicia relating to an advertised product or service in response to a solicitation for such information. This special credit can also be granted by a consumer or seller to reward another webpage user that provides primary or secondary informational indicia relating to a product or service offered by the webpage. The use of this special credit can be restricted by the webpage administrator or seller to encourage the exchange of informational indicia on the webpage, which ideally will promote the sale of the listed product or service. For example, the special credit can be restricted for the exclusive use of a consumer in rewarding the solicitation or publication of primary or secondary informational indicia relating to a specific product or service offered on the webpage. Alternatively, the special credit can be restricted for use in rewarding those that provide, for example, scientific data generated using the relevant product or service, but not informational indicia lacking such data. Accordingly, through the use of special credits, the seller is able to shift the burden for providing informational indicia of a product or service to one or more consumers with little outlay of financial resources. This variation of the methods of invention is particularly attractive for sellers seeking to spur commercial activity on a webpage, to enroll (e.g., to authenticate) new consumers, and to provide depth to the informational indicia available for a product or service, particularly newly available products and services.

In another embodiment of the invention, the webpage seller can use trade credit to promote the sale of certain products, services, and informational indicia. In so doing, the seller has the ability to influence consumer behavior based not only upon the set pricing of the listed products, services, and informational indicia, but also upon restrictions placed on how supplied trade credits may be spent by the consumer. Accordingly, the method and webpage of the invention can feature trade credits that are restricted in use, for example, to the purchase of listed products, services, or informational indicia. In one embodiment, the seller defines a group of products, services, or informational indicia that can be purchased by a consumer with a supplied trade credit.

The actual exchange of money, trade credits, discounts between a host and consumer or between consumers can be facilitated by Internet services specializing in the transfer of money (e.g., Paypal.com, Internet money transfers). Alternatively, the seller can provide a system of debits and credits that a consumer can use to adjust the cost of future product and service purchases from the seller.

### ADVANTAGES

The present method of commerce and information exchange offers several advantages over current methods of buying, selling, and reviewing products and services on a webpage. First, the methods of the invention take full advantage of the expertise and experience of others (e.g., consumers) in providing useful and relevant information concerning a particular product or service. In practice, a seller can not typically perform all of the quality control tests and experiments necessary to enable the broadest use of a given product or services. By allowing others to use and evaluate the offered products and services, both the seller and consumer will gain insight into the quality and applicability of these products and services. Accordingly, the methods of the present invention can be used to effectively shift the burden of supplying information and quality control from the seller to the consumer, provided the seller provides enough product or service indicia to provoke the participation of one or more consumers according to the methods described herein. Second, by allowing for flexibility in the exchange of compensation between the seller and the consumer, or directly between two or more consumers, the methods of the invention provide increased incentive and opportunity for consumers to publish product and service indicia. Supposing that consumer-supplied product or service indicia indicates the utility or reliability of a given product or service, it is likely the seller will realize increased sales volume or profit.

### EXAMPLES

It will be apparent to those skilled in the art that various modifications and variations can be made to the methods of the present invention without departing from the spirit or scope of the invention. Thus, it is intended that the present invention cover the modifications and variations of this invention provided they come within the scope of the appended claims and their equivalents.

### Example 1

### Request, Purchase, and Review of an Antibody

A scientist (“consumer A”) needs a mouse anti-human CD8 molecule for use in a Western blot assay. Consumer A finds such an antibody advertised on a webpage operated according to the methods of the present invention. After registering with the webpage by providing personal information, the seller operating the webpage transfers a trade credit to consumer A's account to be used towards the purchase of an advertised product or service, or to reward another webpage user (e.g., another consumer) for providing informational indicia upon solicitation. In order to learn more about the advertised antibody and its application in Western blotting protocols, consumer A solicits a review of the antibody on the webpage. Upon notice of the solicitation, consumer B, a research scientist who has previously purchased and used the antibody in Western blot assays, publishes data on the webpage, including photographs of exemplary Western blots. In exchange for the publication, consumer A transfers a trade credit to consumer B's account.

### Example 2

### Multiple Consumers Solicit Informational Indicia

A scientist (“consumer A”) is interested in a microarray chip useful for genomic analysis that is offered on a webpage operated according to the methods of the present invention. Consumer A registers on the webpage and receives a complementary trade credit that can be given to another webpage user (e.g., another consumer) for providing informational indicia relating to an advertised product or service. After posting a solicitation for exemplary data generated using the advertised microarray chip, three different consumers (consumers “B, C, and D”) also express interest in obtaining exemplary data generated using the advertised microarray. Consumers A-D pool their respective trade credits to increase the incentive and reward to another consumer (consumer “E”) to provide the requested data. Following the publication of the microarray data, trade credits from consumers A-D are transferred to consumer E's account.

### Other Embodiments

While the invention has been described in connection with specific embodiments thereof, it will be understood that it is capable of further modifications and this application is intended to cover any variations, uses, or adaptations of the invention following, in general, the principles of the invention and including such departures from the present disclosure that come within known or customary practice within the art to which the invention pertains and may be applied to the essential features hereinbefore set forth.

All publications and patent applications mentioned in this specification are herein incorporated by reference to the same extent as if each independent publication or patent application was specifically and individually indicated to be incorporated by reference in their entirety.

What is claimed is:

1. A method for commerce and information exchange comprising the steps of:
(a) listing one or more products or services on a webpage;
(b) registering a first consumer and a second consumer, wherein said first and second consumers are not affiliated or associated with the operation or ownership of said webpage; and
(c) publishing informational indicia relating to said products or services on said webpage, wherein said indicia are solicited by said first consumer and provided by said second consumer.

2. The method of claim 1, wherein said method further comprises: step (d) processing an exchange of compensation between said first and second consumers upon publication of informational indicia relating to said one or more products or services on said webpage.

3. A method for commerce and information exchange comprising the steps of:
(a) listing one or more products or services on a webpage;
(b) registering a first consumer and a second consumer, wherein said first and second consumers are not affiliated or associated with the operation or ownership of said webpage; and
(c) processing an exchange of compensation between said first and second consumers upon publication of informational indicia relating to said one or more products or services on said webpage.

4. The method of claim 1, wherein said services comprise the manufacture, purification, or distribution of a biological or chemical product.

5. The method of claim 1, wherein said products comprise a biological or chemical product.

6.-13. (canceled)

14. The method of claim 1, wherein said informational indicia comprise a review, critique, explanation, survey score, or ranking, or scientific data.

15. (canceled)

16. The method of claim 1, wherein said informational indicia comprise a drawing, photograph, or video.

17.-19. (canceled)

20. The method of claim 1, wherein step (b) further comprises registering a third consumer.

21. The method of claim 1, wherein step (b) further comprises publishing consumer information of said first and second consumers on said webpage.

22. (canceled)

23. The method of claim 1, wherein said webpage is publicly accessible.

24.-32. (canceled)

33. A webpage for commerce and information exchange comprising:
(a) a webpage that lists one or more products or services;
(b) means for registering a first consumer and a second consumer, wherein said first and second consumers are not affiliated or associated with the operation or ownership of said webpage; and
(c) means for publishing informational indicia of said products or services on said webpage, wherein said indicia are solicited by said first consumer and provided by said second consumer.

34. The webpage of claim 33, wherein said webpage further comprises means for processing an exchange of compensation between said first and second consumers upon publication of said indicia.

35. A webpage for commerce and information exchange comprising:
(a) a webpage that lists one or more products or services;
(b) means for registering a first consumer and a second consumer, wherein said first and second consumers are not affiliated or associated with the operation or ownership of said webpage; and
(c) means for processing an exchange of compensation between said first and second consumers upon publication of said indicia.

36. The webpage of claim 33, wherein said services comprise the manufacture, purification, or distribution of a biological or chemical product.

37. The webpage of claim 33, wherein said products comprise a biological or chemical product.

38.-45. (canceled)

46. The webpage of claim 33, wherein said informational indicia comprise a review, critique, explanation, survey score, ranking, or scientific data.

47. (canceled)

48. The webpage of claim 33, wherein said informational indicia comprise a drawing, photograph, or video.

49.-51. (canceled)

52. The webpage of claim 33, wherein step (b) further comprises registering a third consumer.

53. The webpage of claim 33, wherein step (b) further comprises publishing consumer information of said first and second consumers on said webpage.

54. (canceled)

55. The webpage of claim 33, wherein said webpage is publicly accessible.

56.-64. (canceled)
